(19) United States
(12) Patent Application Publication
(10) Pub. No.: US 2025/0251576 A1
(43) Pub. Date: Aug. 7, 2025

(54) OPTICAL SYSTEM AND IMAGE PICKUP APPARATUS

(71) Applicant: CANON KABUSHIKI KAISHA, Tokyo (JP)

(72) Inventor: Tomohiro INO, Tochigi (JP)

(21) Appl. No.: 18/969,340

(22) Filed: Dec. 5, 2024

(30) Foreign Application Priority Data
Feb. 7, 2024 (JP) 2024-016858

(51) Int. Cl. G02B 13/00; G02B 7/28; H04N 23/55

(52) U.S. Cl. CPC G02B 13/0045; G02B 7/28; G02B 13/006; H04N 23/55

(57) ABSTRACT

An optical system includes, in order from an object side to an image side, a front group having positive refractive power and including a plurality of lens units, an aperture stop, and a rear group having positive refractive power and including a plurality of lens units. During focusing, a first focus lens unit included in the front group and a second focus lens unit included in the rear group move, and thereby a distance between adjacent lens units change. The front group includes a first lens having positive refractive power and disposed closest to an object, and a second lens having negative refractive power and disposed adjacent to and on the image side of the first lens.

### BACKGROUND

### Technical Field The present disclosure relates to an optical system suitable for imaging.

### Description of Related Art

Imaging requires an optical system that has a reduced size, high optical performance, and a large aperture ratio as well as a high focusing (autofocus: AF) speed.

Japanese Patent Application Laid-Open Nos. 2019-197125 and 2023-120952 disclose inner focus type optical systems that drive a focus lens unit provided in the optical system during focusing.

### SUMMARY

An optical system according to one aspect of the disclosure includes, in order from an object side to an image side, a front group having positive refractive power and including a plurality of lens units, an aperture stop, and a rear group having positive refractive power and including a plurality of lens units. During focusing, a first focus lens unit included in the front group and a second focus lens unit included in the rear group move, and thereby a distance between adjacent lens units change. The front group includes a first lens having positive refractive power and disposed closest to an object, and a second lens having negative refractive power and disposed adjacent to and on the image side of the first lens. An image pickup apparatus having the above optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of an optical system according to Example 1.

FIG. 2A is a longitudinal aberration diagram of the optical system according to Example 1 in an in-focus state at infinity, and FIG. 2B is a longitudinal aberration diagram of the optical system according to Example 1 in an in-focus state at the closest distance.

FIG. 3 is a sectional view of an optical system according to Example 2.

FIG. 4A is a longitudinal aberration diagram of the optical system according to Example 2 in an in-focus state at infinity, and FIG. 4B is a longitudinal aberration diagram of the optical system according to Example 2 in an in-focus state at the closest distance.

FIG. 5 is a sectional view of an optical system according to Example 3.

FIG. 6A is a longitudinal aberration diagram of the optical system according to Example 3 in an in-focus state at infinity, and FIG. 6B is a longitudinal aberration diagram of the optical system according to Example 3 in an in-focus state at the closest distance.

FIG. 7 is a sectional view of an optical system according to Example 4.

FIG. 8A is a longitudinal aberration diagram of the optical system according to Example 4 in an in-focus state at infinity, and FIG. 8B is a longitudinal aberration diagram of the optical system according to Example 4 in an in-focus state at the closest distance.

FIG. 9 illustrates an image pickup apparatus having the optical system according to any one of Examples 1 to 4.

### DETAILED DESCRIPTION

Referring now to the accompanying drawings, a detailed description will be given of examples according to the disclosure.

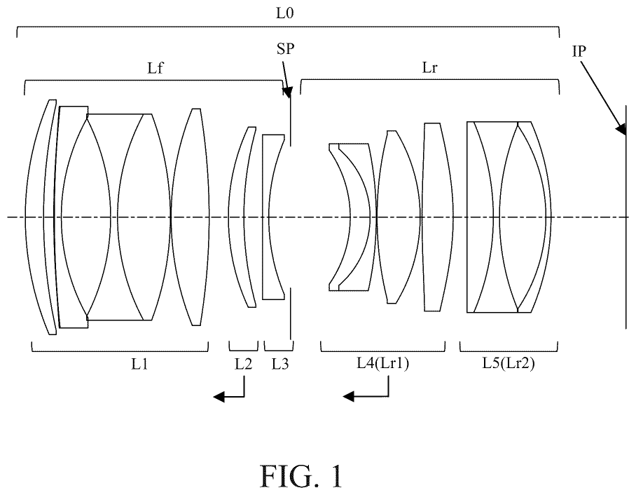

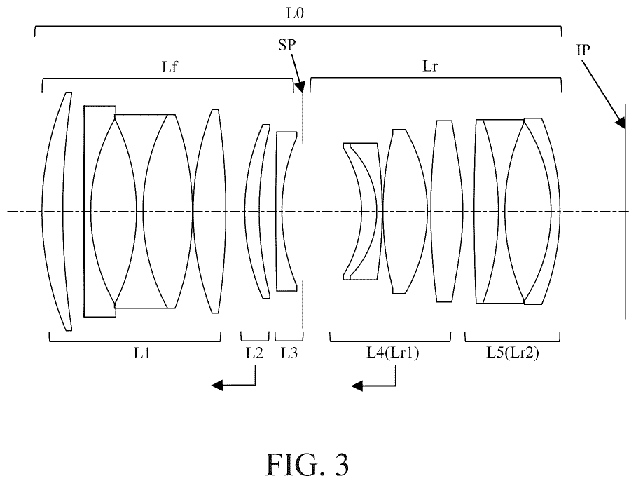

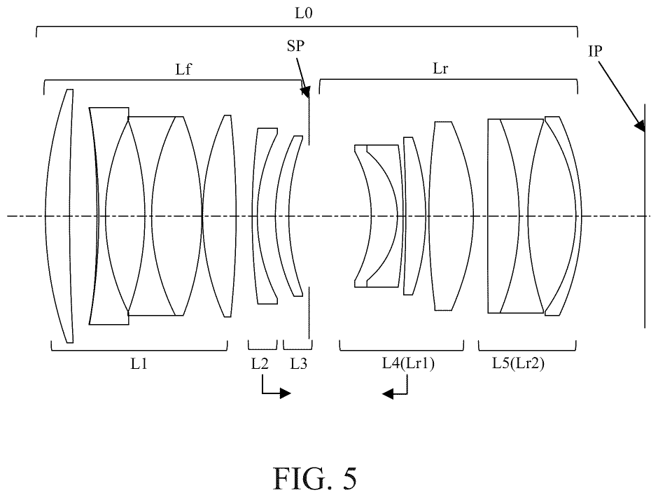

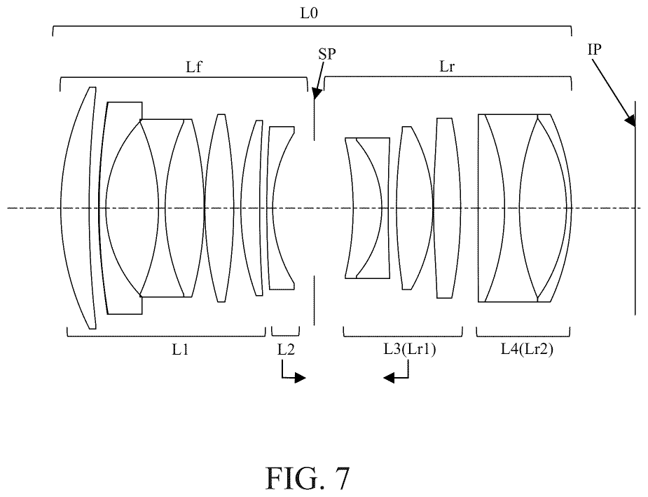

FIGS. 1, 3, 5, and 7 respectively illustrate sections of optical systems L0 according to Examples 1, 2, 3, and 4 of the present disclosure in a state where the optical system is in focus on an object at infinity (hereinafter referred to as “in an in-focus state at infinity”). In each figure, a left side is an object side (front side) and a right side is an image side (rear side).

The optical system L0 according to each example is used as an imaging optical system for various image pickup apparatuses such as video cameras, digital still cameras, broadcasting cameras, film-based cameras, and surveillance cameras. The optical system L0 may be interchangeable with the image pickup apparatus, or may be integrated with the image pickup apparatus.

The optical system L0 according to each example includes, in order from the object side to the image side, a front group Lf having positive refractive power, an aperture stop (diaphragm) SP, and a rear group Lr having positive refractive power. IP represents an image surface. An imaging surface (light receiving surface) of an image sensor (photoelectric conversion element) such as a CCD sensor or CMOS sensor, or a film surface (photosensitive surface) of a silver film is disposed on the image plane IP.

The front group Lf in Examples 1 to 3 includes, in order from the object side to the image side, a first lens unit L1 having positive refractive power, a second lens unit L2 having positive or negative refractive power, and a third lens unit L3 having positive or negative refractive power. The lens unit is one or more lenses that may or may not move as a unit during focusing between infinity and the closest distance. In other words, a distance between adjacent lens units changes during focusing. The rear group Lr in Examples 1 to 3 includes a fourth lens unit L4 having positive refractive power, and a fifth lens unit L5 having positive or negative refractive power.

In Examples 1 to 3, during focusing, the first lens unit L1, the third lens unit L3, and the fifth lens unit L5 are fixed (do not move) relative to the image plane IP, and the second lens unit L2 and the fourth lens unit L4 move relative to the image plane IP. Each figure illustrates a moving direction (object side or image side) of a lens unit that moves during focusing from infinity to a close distance under the lens unit.

The front group Lf in Example 4 includes, in order from the object side to the image side, the first lens unit L1, and the second lens unit L2 having negative refractive power. The rear group Lr in Example 4 includes the third lens unit L3 having positive refractive power, and the fourth lens unit L4 having positive or negative refractive power. In Example 4, during focusing, the first lens unit L1 and the fourth lens unit L4 are fixed (do not move) relative to the image plane IP, and the second lens unit L2 and the third lens unit L3 move relative to the image plane IP.

For fast focusing (AF) in an optical system that has a reduced size, high performance, a wide angle of view and a large aperture ratio, it is important to properly arrange the lens units in the optical system and properly set the configuration and arrangement of the focus lens unit that moves during focusing. In the optical system L0 according to each example, a part of the focus lens units among a plurality of lens units in the optical system is moved to achieve aberration correction and the weight reduction of the focus lens unit.

Distributing power to the two focus lens units can easily suppress fluctuations in aberrations during focusing, particularly astigmatism, coma, and lateral chromatic aberration.

The characteristics of the optical system L0 according to each example will now be described.

In Examples 1 to 4, the first lens unit L1 in the front group Lf having positive refractive power, is disposed closest to the object, has a first lens having positive refractive power and closest to the object. The term “lens” here includes various types of lenses, such as a single lens, a cemented lens in which lenses of different materials are joined together, and a lens made of an inorganic material such as glass on a surface of which a layer made of an organic material such as resin is provided. In numerical examples 1 to 4 corresponding to Examples 1 to 4, respectively, the first lens includes a single lens. The first lens having positive refractive power can converge an incident light beam, and reduce a diameter of lens on the image side of the first optical element in the first lens unit L1, a lens in the second lens unit L2, and the weight of each lens.

In Examples 1 to 4, the first lens unit L1 includes a second lens having negative refractive power and disposed adjacent to and on the image side of the first lens. In each numerical example, the second lens has a configuration in which a resin layer is provided on an object-side surface of the single lens. In Examples 1 to 4, the second lens has an aspheric surface. In each numerical example, an object-side surface of the resin layer is aspheric.

In Examples 1 and 2, the second lens unit L2, which is the first focus lens unit that moves during focusing in the front group Lf, includes a single lens having positive refractive power or a cemented lens having positive refractive power. In numerical examples 1 and 2, the second lens unit L2 includes a single lens having positive refractive power. In Examples 1 and 2, the second lens unit L2 moves toward the object side during focusing from infinity to a close distance.

In Examples 3 and 4, the second lens unit L2, which is the first focus lens unit that moves during focusing in the front group Lf, includes a single lens having negative refractive power or a cemented lens having negative refractive power. In numerical examples 3 and 4, the second lens unit L2 includes a single lens having negative refractive power. In Examples 3 and 4, the second lens unit L2 moves toward the image side during focusing from infinity to a close distance.

Thus, the second lens unit L2 that moves during focusing and includes a single lens can easily increase a focusing speed.

In Examples 1 and 2, the third lens unit L3, which is closest to the image plane in the front group Lf, includes a single lens having negative refractive power or a cemented lens having negative refractive power. In numerical examples 1 and 2, the third lens unit L3 includes a single lens having negative refractive power. In Example 3, the third lens unit L3, which is closest to the image plane in the front group Lf, includes a single lens having positive refractive power or a cemented lens having positive refractive power. In numerical example 3, the third lens unit L3 includes a single lens having positive refractive power.

In Examples 1 to 3, an aperture stop SP is disposed between the third lens unit L3 and the fourth lens unit L4. In Example 4, an aperture stop SP is disposed between the second lens unit L2 and the third lens unit L3.

Each of the fourth lens unit L4 in Examples 1 to 3 and the third lens unit L3 in Example 4 is the second focus lens unit that move toward the object side during focusing from infinity to a close distance. Each of the fourth lens unit L4 in Examples 1 to 3 and the third lens unit L3 in Example 4 includes at least two positive lenses and one negative lens. A cemented lens in which a positive lens and a negative lens are cemented together is counted as one positive lens and one negative lens. This configuration can easily suppress aberration fluctuations during focusing, particularly fluctuations in longitudinal chromatic aberration and spherical aberration.

In Examples 1 to 3, the third lens unit L3, which is fixed during focusing, can easily correct longitudinal chromatic aberration and spherical aberration and suppress an increase in the weight of the focus lens unit.

A description will now be given of a configuration that may be satisfied by the optical system L0 according to each example.

In Examples 1 to 4, the first lens unit L1 may have an aspheric surface. The first lens unit L1 having an aspheric surface and disposed at a position where off-axis rays are located at a high position can satisfactorily correct curvature of field, astigmatism, and distortion.

The second rear lens unit Lr2 (fifth lens unit L5 in Examples 1 to 3, fourth lens unit L4 in Example 4) is disposed closest to the image plane in the rear group Lr in Examples 1 to 4 and may include at least one positive lens and two negative lenses. In each example, the lens unit closest to the image plane has the above configuration, which is effective in correcting Petzval sum and facilitating the correction of curvature of field.

The first rear lens unit Lr1 (fourth lens unit L4 in Examples 1 to 3, third lens unit L3 in Example 4) is closest to the object in the rear group Lr in Examples 1 to 4 and may include, in order from the object side to the image side, a cemented lens, a biconvex positive lens, and a positive lens. The number of lenses constituting the first rear lens unit Lr1 can be reduced and the weight of the focus lens unit can be reduced.

Placing a cemented lens in the first rear lens unit Lr1 at a position closest to the object in the rear group Lr whose lens diameter can be easily reduced can easily correct longitudinal chromatic aberration while suppressing an increase in weight as a focus lens unit.

In Examples 1 to 4, the first rear lens unit Lr1 includes two single lenses having positive refractive power, and the single lens having positive refractive power and disposed on the object side may be a biconvex lens. This configuration can easily correct aberrations by dispersing the positive power, while reducing a moving amount of the focus lens unit and facilitating high-speed focusing.

In Examples 1 to 4, an aperture stop SP may be disposed in the lens unit closest to the image plane in the front group Lf (the third lens unit L3 in Examples 1 to 3, and the second lens unit L2 in Example 4) or at a position adjacent to and on the image side of that lens unit (between the front group Lf and the rear group Lr). The aperture stop SP disposed near the center of the optical system L0 can improve the symmetry of the optical system L0 in front of and behind the aperture stop SP, and coma and distortion can be easily corrected.

In Examples 1 to 4, the focusing lens unit in the front group Lf and the focusing lens unit in the rear group Lr may move by different moving amounts during focusing. This configuration can easily correct aberrations in an in-focus state on an object at the closest distance (referred to as “in an in-focus state at the closest distance” hereinafter).

A description will now be given of inequalities that the optical system L0 according to each example may satisfy. The optical system L0 according to each example may satisfy at least one of the following inequalities (1) to (15):

$$0.5 \leq f 1 / f \leq 4. \qquad ( 1 )$$

$$0.02 \leq LD 1 / f \leq 0.15 \qquad ( 2 )$$

$$0.1 \leq SK / f \leq 0.6 \qquad ( 3 )$$

$$15 \leq vd 1 \leq 30 \qquad ( 4 )$$

$$0.2 \leq T 1 / f \leq 1.5 \qquad ( 5 )$$

$$0.01 \leq T 2 / f \leq 0.30 \qquad ( 6 )$$

$$0.1 \leq Tr 1 / f \leq 0.9 \qquad ( 7 )$$

$$0.2 \leq Tr 2 / f \leq 0.9 \qquad ( 8 )$$

$$0.5 \leq fLf / f \leq 5. \qquad ( 9 )$$

$$0.2 \leq fLr / f \leq 5. \qquad ( 10 )$$

$$0.5 \leq fLf / fLr \leq 4. \qquad ( 11 )$$

$$0.2 \leq fL 1 / f \leq 5. \qquad ( 12 )$$

$$0.5 \leq \vert fL 2 \vert / f \leq 5. \qquad ( 13 )$$

$$0.1 \leq fLr 1 / f \leq 4. \qquad ( 14 )$$

$$- 7. \leq fLr 2 / f \leq - 0.2 \qquad ( 15 )$$

In inequality (1) to (15), f is a focal length of the optical system L0 in an in-focus state at infinity. f1 is a focal length of the first lens in the first lens unit L1, and f2 is a focal length of the second lens in the first lens unit L1. LD1 is an air gap on the optical axis between the first lens and the second lens. SK is an air equivalent distance (back focus) on the optical axis from a lens surface closest to the image plane of the optical system L0 to the image surface (paraxial image surface) IP. T1 is a distance on the optical axis from a lens surface closest to the object in the first lens unit L1 to a lens surface closest to the image plane in the first lens unit L1. T2 is a distance on the optical axis from a lens surface closest to the object in the second lens unit L2 to a lens surface closest to an image plane in the second lens unit L2. Tr1 is a distance (thickness) on the optical axis from a lens surface closest to the object in the first rear lens unit Lr1 of the rear group Lr to a lens surface closest to the image plane of the lens unit closest to the object in the first rear lens unit Lr1. Tr2 is a distance (thickness) on the optical axis from a lens surface closest to the object in the second rear lens unit Lr2 in the rear group Lr to a lens surface closest to the image plane of the lens unit closest to the image plane in the second rear lens unit Lr2.

vd1 is an Abbe number based on the d-line of the first lens. fLf is a focal length of the front group Lf, and fLr is a focal length of the rear group Lr. fL1 is a focal length of the first lens unit L1, fL2 is a focal length of the second lens unit L2, and fLr1 is a focal length of the first rear lens unit Lr1 in the rear group Lr. fLr2 is a focal length of the second rear lens unit Lr2 in the rear group Lr.

Inequality (1) defines a proper relationship between the focal length f1 of the first lens and the focal length f of the optical system L0. In a case where f1/f becomes lower than the lower limit of inequality (1), the focal length of the first lens becomes too short, i.e., the refractive power of the first lens becomes too strong, and it becomes difficult to correct astigmatism and spherical aberration. On the other hand, in a case where f1/f becomes higher than the upper limit of inequality (1), the focal length of the first lens becomes too long, i.e., the refractive power of the first lens becomes too weak, and it becomes difficult to sufficiently converge a light beam entering the optical system L0. As a result, it becomes difficult to reduce the diameters of the lenses on the image side of the first lens in the first lens unit L1, and the weight of the optical system L0 increases.

Inequality (2) defines a proper relationship between the air gap LD1 between the first lens and the second lens and the focal length f of the optical system L0. In a case where the distance between the first lens and the second lens becomes too narrow so that LD1/f becomes lower than the lower limit of inequality (2), it becomes necessary to arrange the second lens and subsequent lenses in the first lens unit L1 before the light beam incident on the first lens converges. As a result, the diameters of the lenses after the second lens increase, and the weight of the optical system L0 increases. In a case where the distance between the first lens and the second lens becomes too wide so that LD1/f becomes higher than the upper limit of inequality (2), it becomes necessary to increase the overall length of the optical system L0 and the size of the optical system L0 increases.

Inequality (3) defines a proper relationship between the back focus SK and the focal length f of the optical system L0. In a case where the back focus increases so that SK/f becomes higher than the upper limit of inequality (3), the size of the optical system L0 increases. In a case where the back focus reduces so that SK/f becomes lower than the lower limit of inequality (3), it becomes difficult to place an image sensor and an optical block such as a low-pass filter near the image plane.

Inequality (4) defines a proper range of the Abbe number vd1 of the first lens, which is a positive lens. In a case where vd1 becomes lower than the lower limit of inequality (4), excessive longitudinal chromatic aberration occurs in the first lens. In a case where vd1 becomes higher than the upper limit of inequality (4), the correction of longitudinal chromatic aberration becomes insufficient.

Inequality (5) defines a proper relationship between the thickness T1 of the first lens unit L1 and the focal length f of the optical system L0. In a case where the thickness of the first lens unit L1 increases so that T1/f becomes higher than the upper limit of inequality (5), the size of the optical system L0 increases. In a case where the thickness of the first lens unit L1 reduces so that T1/f becomes lower than the lower limit of inequality (5), it becomes difficult to correct aberrations, particularly distortion, that occur in the first lens unit L1.

Inequality (6) defines a proper relationship between the thickness T2 of the second lens unit L2 and the focal length f of the optical system L0. In a case where the thickness of the second lens unit L2 increases so that T2/f becomes higher than the upper limit of inequality (6), the size of the optical system L0 increases. In a case where the thickness of the second lens unit L2 reduces so that T2/f becomes lower than the lower limit of inequality (6), it becomes difficult to correct aberrations, particularly distortion, that occur in the second lens unit L2.

Inequality (7) defines a proper relationship between the thickness Tr1 of the first rear lens unit Lr1 and the focal length f of the optical system L0. In a case where the thickness of the first rear lens unit Lr1 increases so that Tr1/f becomes higher than the upper limit of inequality (7), the weight of the first rear lens unit Lr1 increases, and it becomes difficult to achieve high-speed focusing. In a case where the thickness of the first rear lens unit Lr1 reduces so that Tr1/f becomes lower than the lower limit of inequality (7), it becomes difficult to correct aberrations, particularly spherical aberration and astigmatism, that occur in the first rear lens unit Lr1.

Inequality (8) defines a proper relationship between the thickness Tr2 of the second rear lens unit Lr2 and the focal length f of the optical system L0. In a case where the thickness of the second rear lens unit Lr2 increases so that Tr2/f becomes higher than the upper limit of inequality (8), the size of the optical system L0 increases. In a case where the thickness of the second rear lens unit Lr2 reduces so that Tr2/f becomes lower than the lower limit of inequality (8), it becomes difficult to correct curvature of field and distortion.

Inequality (9) defines a proper relationship between the focal length fLf of the front group Lf and the focal length f of the optical system L0. In a case where the focal length of the front group Lf increases, that is, the refractive power of the front group Lf becomes weak so that fLf/f becomes higher than the upper limit of inequality (9), a light converging effect reduces. As a result, the diameter of the light beam passing through the second lens unit L2 and the aperture stop SP increases and it becomes difficult to reduce the size of the optical system L0. In a case where the focal length of the front group Lf reduces, that is, the refractive power of the front group Lf becomes strong so that fLf/f becomes lower than the lower limit of inequality (9), it becomes difficult to correct the spherical aberration and astigmatism that occur in the front group Lf.

The inequality (10) defines a proper relationship between the focal length fLr of the rear group Lr and the focal length f of the optical system L0. In a case where the focal length of the rear group Lr increases, that is, the refractive power of the rear group Lr becomes weaker so that fLr/f becomes higher than the upper limit of inequality (10), it becomes difficult to correct off-axis aberrations occurring in the front group Lf, particularly lateral chromatic aberration and distortion. In a case where the focal length of the rear group Lr reduces, that is, the refractive power of the rear group Lr becomes stronger so that fLr/f becomes lower than the lower limit of inequality (10), it becomes difficult to correct off-axis aberrations occurring in the rear group Lr, particularly lateral chromatic aberration and distortion.

Inequality (11) defines a proper relationship between the focal length fLf of the front group Lf and the focal length fLr of the rear group Lr. In a case where the focal length of the rear group Lr reduces, that is, the refractive power of the second lens unit L2 becomes strong so that fLf/fLr becomes higher than the upper limit of inequality (11), curvature of field occurring in the rear group Lr increases and becomes difficult to correct. In a case where the focal length of the front group Lf reduces, that is, the refractive power of the front group Lf becomes strong so that fLf/fLr becomes lower than the lower limit of inequality (11), it becomes difficult to correct spherical aberration and astigmatism occurring in the front group Lf.

Inequality (12) defines a proper relationship between the focal length fL1 of the first lens unit L1 and the focal length f of the optical system L0. In a case where the focal length of the first lens unit L1 reduces, that is, the refractive power of the first lens unit L1 is strong so that fL1/f becomes higher than the upper limit of inequality (12), it becomes difficult to correct spherical aberration and astigmatism occurring in the first lens unit L1. In a case where the focal length of the first lens unit L1 increases, that is, the refractive power of the first lens unit L1 is weak so that fL1/f becomes lower than the lower limit of inequality (12), the overall length of the optical system L0 increases, and the size reduction becomes difficult.

Inequality (13) defines a proper relationship between the focal length fL2 of the second lens unit L2 and the focal length f of the optical system L0. In a case where the focal length of the second lens unit L2 reduces so that |fL2|/f becomes higher than the upper limit of inequality (13), the weight of the second lens unit L2 increases, and it becomes difficult to achieve high-speed focusing. In a case where the focal length of the second lens unit L2 increases so that |fL2|/f becomes lower than the lower limit of inequality (13), it becomes difficult to correct the fluctuation of aberrations, especially astigmatism, during focusing.

Inequality (14) defines a proper relationship between the focal length fLr1 of the first rear lens unit Lr1 of the rear group Lr and the focal length f of the optical system L0. In a case where the focal length of the first rear lens unit Lr1 reduces so that fLr1/f becomes higher than the upper limit of inequality (14), the weight of the second lens unit L2 that moves together with the first rear lens unit Lr1 during focusing increases, it becomes difficult to achieve high-speed focusing. In a case where the focal length of the first rear lens unit Lr1 increases so that fLr1/f becomes lower than the lower limit of inequality (14), it becomes difficult to correct fluctuations in aberrations, particularly spherical aberration and longitudinal chromatic aberration, during focusing.

Inequality (15) defines a proper relationship between the focal length fLr2 of the second rear lens unit Lr2 and the focal length f of the optical system L0. In a case where the focal length of the second rear lens unit Lr2 reduces so that fLr2/f becomes higher than the upper limit of inequality (15), it becomes difficult to correct the Petzval sum and suppress curvature of field. In a case where the focal length of the second rear lens unit Lr2 increases so that fLr2/f becomes lower than the lower limit of inequality (15), it becomes difficult to secure the back focus.

Inequality (1) to (15) may be replaced with inequalities (1a) to (15a) below:

$$1. \leq f 1 / f \leq 3.5 \qquad ( 1 a )$$

$$0.025 \leq LD 1 / f \leq 0.1 \; 30 \qquad ( 2 a )$$

$$0.15 \leq SK / f \leq 0.40 \qquad ( 3 a )$$

$$17 \leq vd 1 \leq 28 \qquad ( 4 a )$$

$$0.5 \leq T 1 / f \leq 1.2 \qquad ( 5 a )$$

$$0.015 \leq T 2 / f \leq 0.1 \; 50 \qquad ( 6 a )$$

$$0.3 \leq Tr 1 / f \leq 0.7 \qquad ( 7 a )$$

$$0.25 \leq Tr 2 / f \leq 0.70 \qquad ( 8 a )$$

$$1. \leq fLf / f \leq 3. \qquad ( 9 a )$$

$$0.3 \leq fLr / f \leq 3. \qquad ( 10 a )$$

$$0.7 \leq fLf / fLr \leq 3. \qquad ( 11 a )$$

$$0.3 \leq fL 1 / f \leq 3. \qquad ( 12 a )$$

$$0.7 \leq \vert fL 2 \vert / f \leq 3. \qquad ( 13 a )$$

$$0.2 \leq fLr 1 / f \leq 3. \qquad ( 14 a )$$

$$- 5. \leq fLr 2 / f \leq - 0.5 \qquad ( 15 a )$$

Inequality (1) to (15) may be replaced with inequalities (1b) to (15b) below:

$$1.5 \leq f 1 / f \leq 3. \qquad ( 1 b )$$

$$0.03 \leq LD 1 / f \leq 0.12 \qquad ( 2 b )$$

$$0.2 \leq SK / f \leq 0.35 \qquad ( 3 b )$$

$$20 \leq vd 1 \leq 26 \qquad ( 4 b )$$

$$0.7 \leq T 1 / f \leq 0.9 \qquad ( 5 b )$$

$$0.02 \leq T 2 / f \leq 0.07 \qquad ( 6 b )$$

$$0.4 \leq Tr 1 / f \leq 0.5 \qquad ( 7 b )$$

$$0.3 \leq Tr 2 / f \leq 0.4 \qquad ( 8 b )$$

$$1.5 \leq fLf / f \leq 2.5 \qquad ( 9 b )$$

$$0.5 \leq fLr / f \leq 1.5 \qquad ( 10 b )$$

$$1. \leq fLf / fLr \leq 2. \qquad ( 11 b )$$

$$0.5 \leq fL 1 / f \leq 1.5 \qquad ( 12 b )$$

$$1. \leq \vert fL 2 \vert / f \leq 2. \qquad ( 13 b )$$

$$0.3 \leq fLr 1 / f \leq 1.5 \qquad ( 14 b )$$

$$- 3.5 \leq fLr 2 / f \leq - 1. \qquad ( 15 b )$$

Numerical examples 1 to 4 will now be illustrated. In each numerical example, surface number i indicates the order of a surface counted from the object side. r represents a radius of curvature (mm) of an i-th surface from the object side, d represents a lens thickness or air gap (mm) on the optical axis between i-th and (i+1)-th surfaces, and nd represents a refractive index for the d-line of the optical material between i-th and (i+1)-th surfaces. vd is an Abbe number based on the d-line of the optical material between i-th and (i+1)-th surfaces.

The Abbe number vd based on the d-line is expressed as:

$$v d = ( N d - 1 ) / ( NF - N C )$$

where Nd, NF, and NC are refractive indices for the d-line (587.6 nm), F-line (486.1 nm), and C-line (656.3 nm) in the Fraunhofer line.

A distance d, focal length, F-number, and half angle of view (°) are all values in an in-focus state at infinity.

SK represents back focus (mm) as described above. An overall lens length is a distance on the optical axis from a lens surface closest to the object in the optical system to a lens surface closest to the image plane in the optical system plus the back focus.

An asterisk “*” next to the surface number means that the lens surface has an aspheric shape. The aspheric shape is expressed as follows:

$$x = ( {h}^{2} / R ) / [ 1 + √ \{ 1 - ( 1 + K ) {( h / R )}^{2} \} ] + A 4 \times {h}^{4} + A 6 \times {h}^{6} + A 8 \times {h}^{8} + A 10 \times {h}^{10} + A 12 \times {h}^{12}$$

where x is a displacement amount from a surface vertex in the optical axis direction, h is a height from the optical axis in a direction perpendicular to the optical axis, R is a paraxial radius of curvature, K is a conic constant, and A4, A6, A8, A10, and A12 are aspheric coefficients. The “e+XX” in the conic constant and aspheric coefficient means “×10^{±XX}.”

A distance between lens units includes a distance in an in-focus state at infinity and a distance in an in-focus state at the closest distance (object distance is illustrated in parentheses). An object distance is a distance from the image plane to an object position.

Table 1 summarizes values corresponding to inequalities (1) to (15) in numerical examples 1 to 4. Each numerical example satisfies all inequalities (1) to (15).

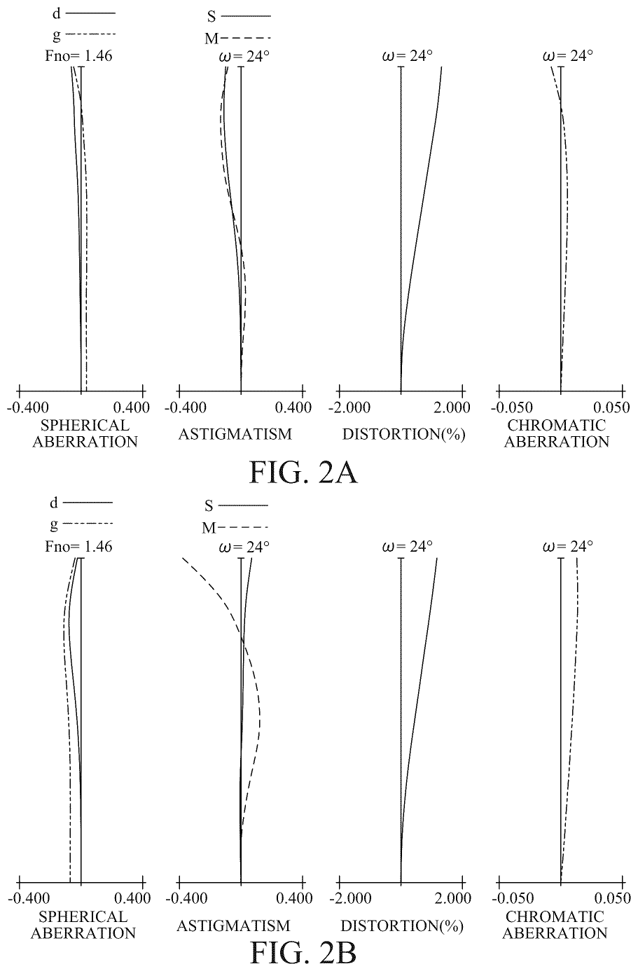

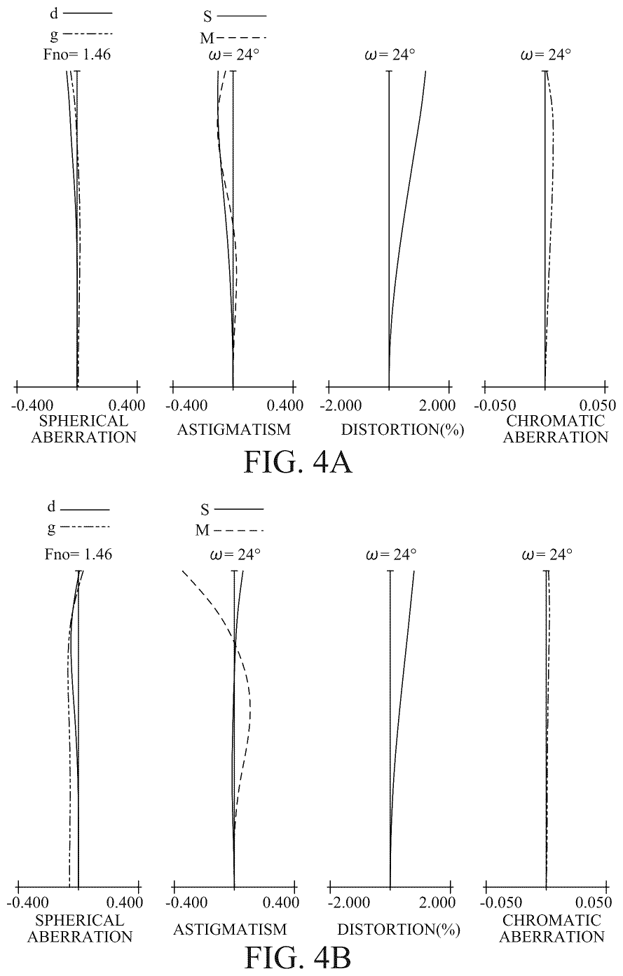

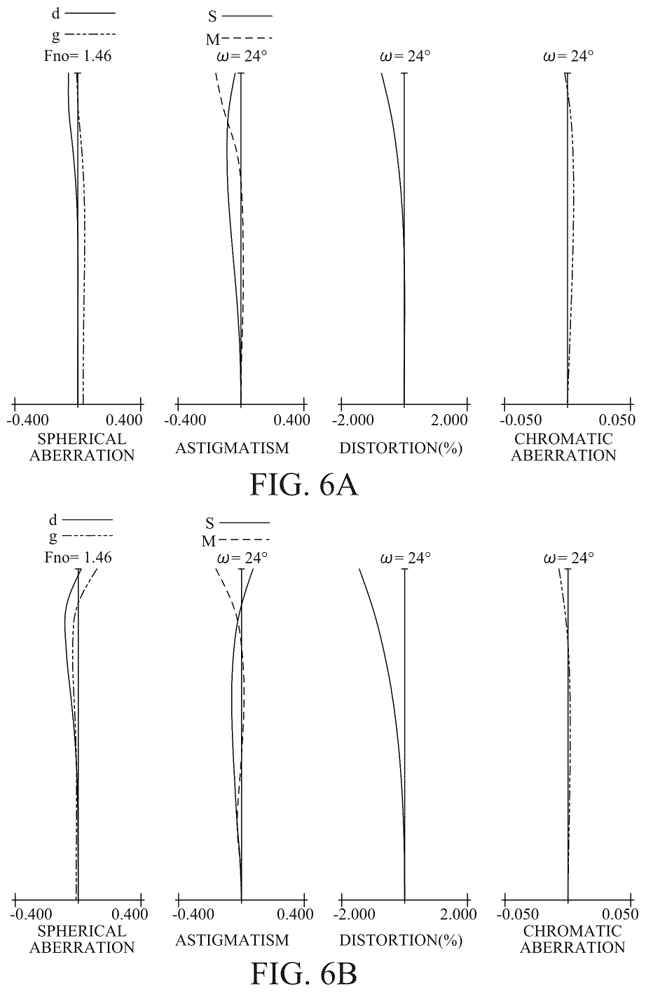

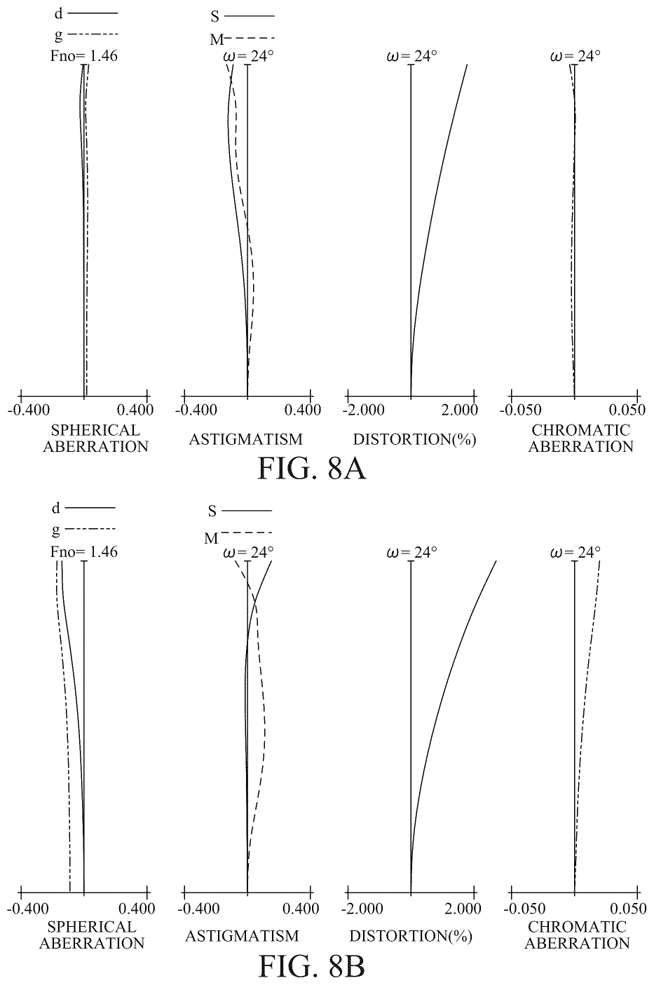

FIGS. 2A, 2B, 4A, 4B, 6A, 6B, 8A, and 8B illustrate the longitudinal aberrations (spherical aberration, astigmatism, distortion, and chromatic aberration) of optical system L0 according to numerical examples 1 to 4 in an in-focus state at infinity and in an in-focus state at the closest distance, respectively. In the spherical aberration diagram, Fno represents an F-number. A solid line indicates a spherical aberration amount for the d-line, and an alternate long and two short dashes line indicates a spherical aberration amount for the g-line (with a wavelength of 435.8 nm). In the astigmatism diagram, a solid line S indicates an astigmatism amount on a sagittal image plane, and a dashed line M indicates an astigmatism amount on a meridional image plane. The distortion diagram illustrates a distortion amount for the d-line. A chromatic aberration diagram illustrates a lateral chromatic aberration amount for the g-line. ω is the half angle of view (°).

### NUMERICAL EXAMPLE 1

UNIT: mm
SURFACE DATA

| Surface No. | r | d | nd | νd |
|---|---|---|---|---|
| 1 | 57.769 | 3.57 | 1.92286 | 20.9 |
| 2 | 99.001 | 2.01 | | |
| 3* | 174.690 | 0.11 | 1.53352 | 52.8 |
| 4 | 207.351 | 1.35 | 1.65412 | 39.7 |
| 5 | 39.088 | 9.65 | | |
| 6 | −41.799 | 1.35 | 1.77047 | 29.7 |
| 7 | 41.799 | 10.34 | 1.76385 | 48.5 |
| 8 | −56.227 | 0.15 | | |
| 9 | 55.362 | 7.44 | 1.91082 | 35.2 |
| 10 | −126.226 | (Variable) | | |
| 11 | 41.162 | 3.03 | 1.90043 | 37.4 |
| 12 | 62.716 | (Variable) | | |
| 13 | ∞ | 1.20 | 1.77047 | 29.7 |
| 14 | 38.312 | 4.28 | | |
| 15 (SP) | ∞ | (Variable) | | |
| 16 | −22.567 | 3.89 | 1.59522 | 67.7 |
| 17 | −17.388 | 1.20 | 1.73037 | 32.2 |
| 18 | −66.069 | 0.16 | | |
| 19 | 65.372 | 8.43 | 1.49700 | 81.7 |
| 20 | −31.807 | 0.37 | | |
| 21* | 195.760 | 6.10 | 1.80400 | 46.5 |
| 22* | −52.537 | (Variable) | | |
| 23 | ∞ | 5.16 | 2.00100 | 29.1 |
| 24 | −46.593 | 1.20 | 1.58144 | 40.8 |
| 25 | 46.593 | 9.09 | | |
| 26 | −31.535 | 1.00 | 1.72825 | 28.5 |
| 27 | −45.428 | 14.66 | | |
| Image Plane | ∞ | | | |

ASPHERIC DATA
3rd Surface
K = 0.00000e+00 A4 = −3.43375e−07 A6 = −2.73639e−09 A8 = 6.57484e−12
A10 = −1.50535e−14 A12 = 9.83500e−18
21st Surface
K = 0.00000e+00 A4 = −3.27084e−06 A6 = 6.22450e−10 A8 = 1.62557e−11
A10 = −9.43111e−14 A12 = 1.12652e−16
22nd Surface
K= 0.00000e+00 A4 = 6.07848e−06 A6 = −7.76772e−09 A8 = 6.38476e−11
A10 = −1.90658e−13 A12 = 1.91577e−16

| | |
|---|---|
| Focal Length | 48.50 |
| Fno | 1.46 |
| Half Angle of View(°) | 24.04 |
| Image Height | 21.64 |
| Overall Lens Length | 117.49 |
| SK | 14.66 |

| | Infinity | Closest Distance(−400 mm) |
|---|---|---|
| d10 | 3.76 | 1.46 |
| d12 | 3.66 | 5.96 |
| d15 | 11.67 | 7.27 |
| d22 | 2.68 | 7.08 |

LENS UNIT DATA

| Lens Unit | Starting Surface | Focal Length |
|---|---|---|
| 1 | 1 | 53.02 |
| 2 | 11 | 124.70 |
| 3 | 13 | −49.73 |
| 4 | 16 | 38.05 |
| 5 | 23 | −96.43 |

### NUMERICAL EXAMPLE 2

UNIT: mm
SURFACE DATA

| Surface No. | r | d | nd | νd |
|---|---|---|---|---|
| 1 | 61.356 | 4.23 | 2.00069 | 25.5 |
| 2 | 155.534 | 4.23 | | |
| 3* | 836.451 | 0.14 | 1.53352 | 52.8 |
| 4 | 9065.248 | 1.30 | 1.72047 | 34.7 |
| 5 | 37.963 | 9.31 | | |
| 6 | −41.519 | 1.30 | 1.77047 | 29.7 |
| 7 | 40.508 | 10.06 | 1.77250 | 49.6 |
| 8 | −55.412 | 0.15 | | |
| 9 | 56.306 | 6.62 | 1.95375 | 32.3 |
| 10 | −136.914 | (Variable) | | |
| 11 | 43.381 | 2.94 | 1.91082 | 35.2 |
| 12 | 66.751 | (Variable) | | |
| 13 | 730.270 | 1.23 | 1.73037 | 32.2 |
| 14 | 38.613 | 4.26 | | |
| 15 (SP) | ∞ | (Variable) | | |
| 16 | −23.950 | 3.09 | 1.59522 | 67.7 |
| 17 | −18.367 | 1.10 | 1.77047 | 29.7 |
| 18 | −89.141 | 0.15 | | |
| 19 | 61.370 | 9.03 | 1.49700 | 81.5 |
| 20 | −32.482 | 0.69 | | |
| 21* | 123.050 | 6.50 | 1.80400 | 46.5 |
| 22* | −55.009 | (Variable) | | |
| 23 | 397.215 | 4.95 | 2.00100 | 29.1 |
| 24 | −55.804 | 1.30 | 1.58144 | 40.8 |
| 25 | 42.967 | 9.38 | | |
| 26 | −32.640 | 1.82 | 1.62004 | 36.3 |
| 27 | −48.951 | 13.26 | | |
| Image Plane | ∞ | | | |

ASPHERIC DATA
3rd Surface
K = 0.00000e+00 A4 = −4.27090e−07 A6 = −1.54574e−09 A8 = 3.73197e−12
A10 = −1.06510e−14 A12 = 8.55869e−18
21st Surface
K = 0.00000e+00 A4 = −3.25844e−06 A6 = 1.10049e−08 A8 = −3.65477e−11
A10 = 1.02156e−13 A12 = −9.95585e−17
22nd Surface
K = 0.00000e+00 A4 = 5.69279e−06 A6 = 6.86476e−09 A8 = −1.01569e−11
A10 = 5.22676e−14 A12 = −5.29539e−17

| | |
|---|---|
| Focal Length | 48.50 |
| Fno | 1.46 |
| Half Angle of View(°) | 24.04 |
| Image Height | 21.64 |
| Overall Lens Length | 118.50 |
| SK | 13.26 |

| | Infinity | Closest Distance(−400 mm) |
|---|---|---|
| d10 | 3.84 | 1.49 |
| d12 | 3.38 | 5.73 |
| d15 | 11.92 | 7.15 |
| d22 | 2.30 | 7.08 |

LENS UNIT DATA

| Lens Unit | Starting Surface | Focal Length |
|---|---|---|
| 1 | 1 | 55.54 |
| 2 | 11 | 128.35 |
| 3 | 13 | −55.86 |
| 4 | 16 | 39.26 |
| 5 | 23 | −105.72 |

### NUMERICAL EXAMPLE 3

UNIT: mm
SURFACE DATA

| Surface No. | r | d | nd | νd |
|---|---|---|---|---|
| 1 | 73.465 | 4.72 | 1.96300 | 24.1 |
| 2 | 422.069 | 5.34 | | |
| 3* | −247.661 | 0.36 | 1.53352 | 52.8 |
| 4 | −121.885 | 1.30 | 1.73037 | 32.2 |
| 5 | 40.970 | 7.70 | | |
| 6 | −54.419 | 1.30 | 1.73037 | 32.2 |
| 7 | 42.011 | 9.81 | 1.81600 | 46.6 |
| 8 | −52.701 | 0.15 | | |
| 9 | 46.818 | 6.53 | 1.91082 | 35.2 |
| 10 | −182.855 | (Variable) | | |
| 11 | 130.723 | 1.00 | 1.73037 | 32.2 |
| 12 | 34.408 | (Variable) | | |
| 13 | 34.823 | 2.61 | 1.65160 | 58.5 |
| 14 | 42.973 | 3.97 | | |
| 15 (SP) | ∞ | (Variable) | | |
| 16 | −25.856 | 5.09 | 1.67790 | 55.3 |
| 17 | −16.086 | 1.12 | 1.77047 | 29.7 |
| 18 | −97.823 | 0.52 | | |
| 19 | −252.862 | 3.88 | 1.59522 | 67.7 |
| 20 | −46.425 | 0.61 | | |
| 21* | 118.091 | 8.68 | 1.80400 | 46.5 |
| 22* | −36.782 | (Variable) | | |
| 23 | 3113.777 | 6.13 | 2.00100 | 29.1 |
| 24 | −48.745 | 1.70 | 1.59551 | 39.2 |
| 25 | 56.334 | 9.36 | | |
| 26 | −31.432 | 1.10 | 1.63980 | 34.5 |
| 27 | −44.734 | 12.35 | | |
| Image Plane | ∞ | | | |

ASPHERIC DATA
3rd Surface
K = 0.00000e+00 A4 = −3.62263e−06 A6 = −1.08195e−09 A8= 7.95075e−12
A10 = −1.65697e−14 A12 = 1.36913e−17
21st Surface
K = 0.00000e+00 A4 = −3.04370e−06 A6 = 7.00824e−09 A8 = −1.23743e−11
A10 = 1.20496e−14 A12 = 3.82758e−17
22nd Surface
K=0.00000e+00 A4 = 4.39376e−06 A6 = −7.07780e−10 A8 = 2.06014e−11
A10 = −7.70118e−14 A12 = 1.37782e−16

| | |
|---|---|
| Focal Length | 48.50 |
| Fno | 1.46 |
| Half Angle of View (°) | 24.04 |
| Image Height | 21.64 |
| Overall Lens Length | 116.95 |
| SK | 12.35 |

| | Infinity | Closest Distance (−400 mm) |
|---|---|---|
| d10 | 3.13 | 5.35 |
| d12 | 3.53 | 1.31 |
| d15 | 12.14 | 6.60 |
| d22 | 2.81 | 8.35 |

LENS UNIT DATA

| Lens Unit | Starting Surface | Focal Length |
|---|---|---|
| 1 | 1 | 42.31 |
| 2 | 11 | −64.22 |
| 3 | 13 | 250.12 |
| 4 | 16 | 43.54 |
| 5 | 23 | −129.66 |

### NUMERICAL EXAMPLE 4

UNIT: mm
SURFACE DATA

| Surface No. | r | d | nd | νd |
|---|---|---|---|---|
| 1 | 53.816 | 5.80 | 1.96300 | 24.1 |
| 2 | 206.917 | 1.91 | | |
| 3* | 103.952 | 0.15 | 1.53352 | 52.8 |
| 4 | 127.076 | 1.35 | 1.61340 | 44.3 |
| 5 | 25.575 | 10.79 | | |
| 6 | −42.093 | 1.35 | 1.78880 | 28.4 |
| 7 | 42.093 | 7.97 | 1.76385 | 48.5 |
| 8 | −65.152 | 0.15 | | |
| 9 | 69.917 | 5.89 | 1.88300 | 40.8 |
| 10 | −101.196 | 1.45 | | |
| 11 | 51.742 | 3.85 | 1.81600 | 46.6 |
| 12 | 246.678 | (Variable) | | |
| 13 | 239.114 | 1.20 | 1.61340 | 44.3 |
| 14 | 28.689 | 8.48 | | |
| 15 (SP) | ∞ | (Variable) | | |
| 16 | −59.348 | 5.85 | 1.49700 | 81.5 |
| 17 | −20.840 | 1.31 | 1.73037 | 32.2 |
| 18 | 324.994 | 1.68 | | |
| 19 | 103.121 | 7.44 | 1.61800 | 63.3 |
| 20 | −32.793 | 0.15 | | |
| 21* | 152.195 | 5.53 | 1.80400 | 46.5 |
| 22* | −87.314 | (Variable) | | |
| 23 | 9313.997 | 5.43 | 2.00100 | 29.1 |
| 24 | −46.460 | 3.01 | 1.54072 | 47.2 |
| 25 | 46.460 | 9.63 | | |
| 26 | −31.065 | 1.00 | 1.53172 | 48.8 |
| 27 | −44.083 | 13.03 | | |
| Image Plane | ∞ | | | |

ASPHERIC DATA
3rd Surface
K = 0.00000e+00 A4 = −1.99729e−06 A6 = −5.01657e−10 A8 = 1.00336e−12
A10 = 1.92177e−15 A12 = −4.72109e−18
21st Surface
K = 0.00000e+00 A4 = −1.96390e−06 A6 = −8.86488e−09 A8= 3.81302e−11
A10 = −1.09819e−13 A12 = 8.62521e−17
22nd Surface
K = 0.00000e+00 A4 = 2.83578e−06 A6 = −1.38704e−08 A8 = 5.99084e−11
A10 = −1.43518e−13 A12 = 1.10064e−16

| | |
|---|---|
| Focal Length | 48.50 |
| Fno | 1.46 |
| Half Angle of View(°) | 24.04 |
| Image Height | 21.64 |
| Overall Lens Length | 117.40 |
| SK | 13.03 |

| | Infinity | Closest Distance (−400 mm) |
|---|---|---|
| d12 | 1.47 | 5.08 |
| d15 | 7.97 | 4.85 |
| d22 | 3.56 | 6.69 |

LENS UNIT DATA

| Lens Unit | Starting Surface | Focal Length |
|---|---|---|
| 1 | 1 | 37.97 |
| 2 | 13 | −53.26 |
| 3 | 16 | 44.53 |
| 4 | 23 | −159.39 |

Numerical Example

| | 1 | 2 | 3 | 4 |
|---|---|---|---|---|
| (1) f/f | 2.975 | 2.042 | 1.892 | 1.529 |
| (2) LD1/f | 0.041 | 0.087 | 0.110 | 0.039 |
| (3) SK/f | 0.302 | 0.273 | 0.255 | 0.269 |
| (4) νd1 | 20.881 | 25.458 | 24.110 | 24.110 |
| (5) T1/f | 0.742 | 0.770 | 0.767 | 0.838 |
| (6) T2/f | 0.063 | 0.061 | 0.021 | 0.025 |
| (7) Tr1/f | 0.415 | 0.424 | 0.410 | 0.453 |
| (8) Tr2/f | 0.339 | 0.360 | 0.377 | 0.393 |
| (9) fLf/f | 1.984 | 1.873 | 1.598 | 2.140 |
| (10) fLr/f | 1.167 | 1.179 | 1.270 | 1.148 |
| (11) fLf/fLr | 1.701 | 1.588 | 1.258 | 1.863 |
| (12) fL1/f | 1.093 | 1.145 | 0.872 | 0.783 |
| (13) \| fl2 \| /f | 2.571 | 2.646 | 1.324 | 1.098 |
| (14) fLr1/f | 0.785 | 0.810 | 0.898 | 0.918 |
| (15) fLr2/f | −1.988 | −2.180 | −2.673 | −3.286 |

### Image Pickup Apparatus

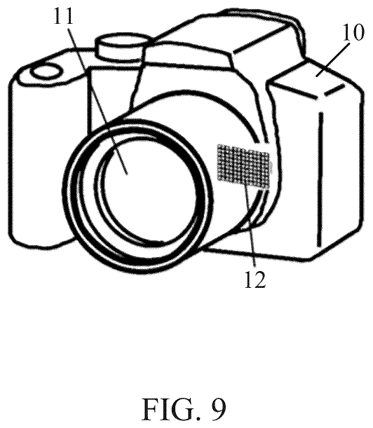

FIG. 9 illustrates a digital still camera (image pickup apparatus) that uses the optical system L0 according to any one of Examples 1 to 4 as the imaging optical system.

Reference numeral 10 denotes a camera body, and reference numeral 11 denotes an imaging optical system including any one of the optical systems L0 according to Examples 1 to 4. Reference numeral 12 denotes a solid-state image sensor (photoelectric conversion element) such as a CCD sensor or CMOS sensor that is built into the camera body 10 and captures an optical image formed by the imaging optical system 11 (i.e., an object through the imaging optical system 11).

The camera body 10 may be a single-lens reflex camera having a quick-turn mirror, or a mirrorless camera having no quick-turn mirror.

Applying the optical system L0 according to any one of Examples 1 to 4 to an image pickup apparatus such as a digital still camera can provide an image pickup apparatus that has a wide angle of view, a large aperture ratio, a reduced size, high optical performance, and a high AF speed.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an optical system that has a reduced size, a large aperture ratio, a reduced weight, and a high AF speed.

This application claims priority to Japanese Patent Application No. 2024-016858, which was filed on Feb. 7, 2024, and which is hereby incorporated by reference herein in its entirety.

What is claimed is:

1. An optical system comprising, in order from an object side to an image side:
a front group having positive refractive power and including a plurality of lens units;
an aperture stop; and
a rear group having positive refractive power and including a plurality of lens units,
wherein during focusing, a first focus lens unit included in the front group and a second focus lens unit included in the rear group move, and thereby a distance between adjacent lens units change, and
wherein the front group includes:
a first lens having positive refractive power and disposed closest to an object, and
a second lens having negative refractive power and disposed adjacent to and on the image side of the first lens.

2. The optical system according to claim 1, wherein the first lens is a single lens.

3. The optical system according to claim 1, wherein the second lens includes a resin layer on an object-side surface of a single lens, and
wherein an object-side surface of the resin layer is aspheric.

4. The optical system according to claim 1, wherein the following inequality is satisfied:
$$0.5 \leq f 1 / f \leq 4.0$$
where f1 is a focal length of the first lens, and f is a focal length of the optical system in an in-focus state on an object at infinity.

5. The optical system according to claim 1, wherein the following inequality is satisfied:
$$0.02 \leq LD 1 / f \leq 0.15$$
where LD1 is an air gap on an optical axis between the first lens and the second lens, and f is a focal length of the optical system in an in-focus state on an object at infinity.

6. The optical system according to claim 1, wherein the following inequality is satisfied:
$$0.1 \leq SK / f \leq 0.6$$
where SK is an air equivalent distance on an optical axis from a lens surface closest to an image plane of the optical system to the image plane, and f is a focal length of the optical system in an in-focus state on an object at infinity.

7. The optical system according to claim 1, wherein the following inequality is satisfied:
$$15 \leq vd 1 \leq 30$$
where vd1 is an Abbe number of the first lens based on d-line.

8. The optical system according to claim 1, wherein the front group includes, in order from the object side to the image side:
a first lens unit having positive refractive power; and
a second lens unit having positive or negative refractive power, and
wherein the second lens unit is the first focus lens unit.

9. The optical system according to claim 8, wherein the front group includes, in order from the object side to the image side:
the first lens unit;
the second lens unit; and
a third lens unit having positive or negative refractive power.

10. The optical system according to claim 1, wherein the front group includes, in order from the object side to the image side:
a first lens unit having positive refractive power; and
a second lens unit having positive or negative refractive power, and
wherein the following inequality is satisfied:
$$0.2 \leq T 1 / f \leq 1.5$$
where T1 is a distance on an optical axis from a lens surface closest to an object in the first lens unit to a lens surface closest to an image plane in the first lens unit, and f is a focal length of the optical system in an in-focus state on an object at infinity.

11. The optical system according to claim 1, wherein the front group includes, in order from the object side to the image side:
a first lens unit having positive refractive power; and
a second lens unit having positive or negative refractive power, and
wherein the following inequality is satisfied:
$$0.01 \leq T 2 / f \leq 0.30$$
where T2 is a distance on an optical axis from a lens surface closest to the object in the second lens unit to a lens surface closest to an image plane in the second lens unit, and f is a focal length of the optical system in an in-focus state on an object at infinity.

12. The optical system according to claim 1, wherein the rear group includes, in order from the object side to the image side:
a first rear lens unit having positive refractive power; and
a second rear lens unit having positive or negative refractive power, and
wherein the first rear lens unit is the second focus lens unit.

13. The optical system according to claim 1, wherein the rear group includes, in order from the object side to the image side:
a first rear lens unit having positive refractive power; and
a second rear lens unit having positive or negative refractive power, and
wherein the following inequality is satisfied:
$$0.1 \leq Tr 1 / f \leq 0.9$$
where Tr1 is a distance on an optical axis from a lens surface closest to the object in the first rear lens unit to a lens surface closest to an image plane in the first rear lens unit, and f is a focal length of the optical system in an in-focus state on an object at infinity.

14. The optical system according to claim 1, wherein the rear group includes, in order from the object side to the image side:
a first rear lens unit having positive refractive power; and
a second rear lens unit having positive or negative refractive power, and
wherein the following inequality is satisfied:
$$0. 2 \leq Tr 2 / f \leq 0.9$$
where Tr2 is a distance on an optical axis from a lens surface closest to the object in the second rear lens unit to a lens surface closest to an image plane in the second rear lens unit, and f is a focal length of the optical system in an in-focus state on an object at infinity.

15. The optical system according to claim 1, wherein the following inequality is satisfied:
$$0.5 \leq fLf / f \leq 5.$$
where fLf is a focal length of the front group, and f is a focal length of the optical system in an in-focus state on an object at infinity.

16. The optical system according to claim 1, wherein the following inequality is satisfied:
$$0. 2 \leq fLr / f \leq 5.$$
where fLr is a focal length of the rear group, and f is a focal length of the optical system in an in-focus state on an object at infinity.

17. The optical system according to claim 1, wherein the following inequality is satisfied:
$$0.5 \leq fLf / fLr \leq 4.0$$
where fLf is a focal length of the front group, and fLr is a focal length of the rear group.

18. The optical system according to claim 1, wherein the front group includes, in order from the object side to the image side:
a first lens unit having positive refractive power; and
a second lens unit having positive or negative refractive power, and
wherein the following inequality is satisfied:
$$0.2 \leq fL 1 / f \leq 5$$
where fL1 is a focal length of the first lens unit, and f is a focal length of the optical system in an in-focus state on an object at infinity.

19. The optical system according to claim 1, wherein the front group includes, in order from the object side to the image side:
a first lens unit having positive refractive power; and
a second lens unit having positive or negative refractive power, and
wherein the following inequality is satisfied:
$$0.5 \leq \vert fL 2 \vert / f \leq 5.$$
where fL2 is a focal length of the second lens unit, and f is a focal length of the optical system in a state focused on an object at infinity.

20. The optical system according to claim 1, wherein the rear group includes, in order from the object side to the image side:
a first rear lens unit having positive refractive power; and
a second rear lens unit having positive or negative refractive power, and
wherein the following inequality is satisfied:
$$0.1 \leq fLr 1 / f \leq 4.0$$
where fLr1 is a focal length of the first rear lens unit, f is a focal length of the optical system in a state focused on an object at infinity.

21. The optical system according to claim 1, wherein the rear group includes, in order from the object side to the image side:
a first rear lens unit having positive refractive power; and
a second rear lens unit having positive or negative refractive power, and
wherein the following inequality is satisfied:
$$- 7.0 \leq fLr 2 / f \leq - 0.2$$
where fLr2 is a focal length of the second rear lens unit, and f is a focal length of the optical system in an in-focus state on an object at infinity.

22. An image pickup apparatus comprising:
an optical system; and
an image sensor configured to image an object through the optical system,
wherein the optical system includes, in order from an object side to an image side:
a front group having positive refractive power and including a plurality of lens units;
an aperture stop; and
a rear group having positive refractive power and including a plurality of lens units,
wherein during focusing, a first focus lens unit included in the front group and a second focus lens unit included in the rear group move, and thereby a distance between adjacent lens units change, and
wherein the front group includes:
a first lens having positive refractive power and disposed closest to the object, and
a second lens having negative refractive power and disposed adjacent to and on the image side of the first lens.
